(19) United States
(12) Patent Application Publication
(10) Pub. No.: US 2008/0122287 A1
(43) Pub. Date: May 29, 2008

(54) Method and apparatus for dynamically controlling pressure within a vehicle brake system

(76) Inventors: Hongxing Wei, Novi, MI (US); David Weber, South Lyon, MI (US); Mark Haller, Canton, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/978,549

(22) Filed: Oct. 29, 2007

Related U.S. Application Data
(63) Continuation of application No. PCT/US2006/016176, filed on Apr. 27, 2006.
(60) Provisional application No. 60/676,395, filed on Apr. 29, 2005.

(51) Int. Cl. B60T 8/40; B60T 15/36; B60T 8/36; G06G 7/00

(52) U.S. Cl. 303/116.1; 701/70; 303/84.2; 303/119.1

(57) ABSTRACT

A method for controlling a vehicle wheel brake that includes applying a pulse width modulated voltage to an isolation valve located between a master brake cylinder and the wheel brake to develop a differential pressure across the isolation valve that is applied to the wheel brake. The differential pressure is a function of the duty cycle of the applied voltage. Because the operation of the isolation valve allows a flow of fluid through the valve, changes in the master cylinder pressure are passed through the isolation valve to the wheel brake.

### CROSS-REFERENCE TO RELATED APPLICATIONS

This application is a continuation of International Application No. PCT/us2006/016176, filed Apr. 27, 2006, which claims the benefit of U.S. Provisional Application No. 60/676,395, filed Apr. 29, 2005. The disclosures of both applications are incorporated herein by reference.

### BACKGROUND OF THE INVENTION

This invention relates in general to electronic brake control systems for vehicles and in particular to an apparatus and method for dynamically controlling the hydraulic pressure within an electronic vehicle brake control system.

Electronic vehicle brake control systems are becoming increasingly popular and can incorporate a multitude of functions to assist a vehicle operator in maintaining a vehicle under control. Typical functions provided by an electronic vehicle brake control system may include, for example, Anti-Lock Brakes (ABS), Traction Control (TC) and Vehicle Stability Control (VSC) to include Yaw Stability Control (YSC) and Active Roll Control (ARC).

Referring now to the figures, a typical known vehicle electronic brake system is shown generally at 10. The brake system 10 is diagonally split, with a first circuit 12 connected to a first pressure chamber of a dual chamber master cylinder 14 and operative to control a front right wheel brake and a rear left wheel brake, 16 and 18, respectively. The system 10 also includes a second circuit 20 connected to a second master cylinder pressure chamber and operative to control a front left wheel brake and a rear right wheel brake, 22 and 24, respectively. The master cylinder 14 is mechanically connected to a brake pedal 24 and both master cylinder pressure chambers communicate with a brake fluid reservoir 28.

Considering the first circuit 12, the first pressure chamber of the master cylinder 14 supplies hydraulic fluid to the circuit 12 through a first normally open isolation solenoid valve 30. When TC is provided, the first isolation valve 30 may also be referred to as a TC isolation valve. Two channels are defined within the first circuit by additional normally open isolation solenoid valves 32 and 34 that control supply of brake fluid to the front right and rear left wheel brakes, 16 and 18, respectively. Because the isolation valves 32 and 34 are operative to block the supply of brake fluid to the individual wheel brakes 16 and 18, they are referred to as channel isolation valves. The first circuit 12 also includes a pair of normally closed dump solenoid valves 36 and 38 that are connected between the front right and rear left wheel brakes, 16 and 18, respectively, and a low pressure accumulator 40 that stores brake fluid. Upon actuation, the dump valves 36 and 38 bleed hydraulic fluid from the associated wheel brake 16 and 18 to the accumulator 40. The accumulator 40 also is connected to an inlet port of a hydraulic pump 42 that is driven by an electric motor (not shown). An outlet port of the pump 42 is connected to the channel isolation valves 32 and 34. Thus, when actuated, the pump 42 supplies pressurized brake fluid to the first circuit wheel brakes 16 and 18. A normally closed supply solenoid valve 44 is connected between the pump inlet port and the first pressure chamber of the master cylinder 14. The supply valve 44 may also be referred to as a TC supply valve. When the both supply valve 44 and the pump 42 are actuated, the pump draws brake fluid from the reservoir 28 through the first pressure chamber of the master cylinder 14. When the pump 42 is not actuated and the supply valve 44 and either or both of the dump valves are opened, brake fluid will return from the wheel brakes 16 and 18 to master cylinder 14. Any excess returned brake fluid will flow into the reservoir 28.

The second brake circuit 20 includes similar components that are symmetrically related to the components described above for the first brake circuit 12, Therefore, for the sake of brevity, the components included in the second brake circuit 20 are not described in detail here.

The brake system 10 further includes an Electronic Control Unit (ECU) 50 that is electrically connected to the solenoid valves. The electrical connections are shown by dashed lines in FIG. 1; however, in the interest of clarity, only connections to two of the solenoid valves 30 and 32 are shown. It will be appreciated that similar connections are provided to the other solenoid valves. The ECU 50 is operative to selectively actuate the solenoid valves under the control of a stored algorithm. The ECU 50 also is electrically connected to wheel speed sensors 52 (one shown) for measuring the rotational speed of each of the vehicle wheels. Typically, the brake system 10 would include a wheel speed sensor for each of the vehicle wheels; however, some brake systems include a single rear wheel speed sensor that generates a signal proportional to an average of the rear wheel speed. As shown in FIG. 1, the brake system 10 also includes a single pressure sensor 54 that monitors the pressure in the first brake circuit 20. Brake systems may also include a second pressure sensor for the second brake circuit 20; however, since the hydraulic fluid pressure is the same for both master cylinder pressure chambers, typically only one pressure sensor 54 is needed. The pressure sensor 54 is electrically connected to the ECU 50 and supplies a signal proportional to the pressure being generated within the master cylinder 14. Depending upon the system, the ECU 50 may also be electrically connected to motion sensors, such as a lateral accelerometer (not shown), a yaw sensor (not shown) and/or a directional sensor, such as a steering angle sensor (not shown).

During operation, the ECU 50 continuously monitors output signals received from the various sensors. Upon determining that a vehicle parameter has exceeded a threshold, such as, for example, wheel slip during a brake activation cycle, the ECU 50 is operative to isolate one or both brake circuits 12 and 20, actuate the pump 42 to supply pressurized brake fluid and then selectively actuate the isolation and dump valves to correct the situation. Similarly, upon detecting from the motion and/or direction sensors that the vehicle is departing from its intended direction, the ECU can selectively actuate individual wheel brakes to correct the vehicle course.

Because each brake circuit includes two isolation valves between the master cylinder 14 and each wheel brake, the brake system 10 is often referred to as having “double isolation” from the master cylinder. Thus, while the electronic brake system 10 is operative, the wheel brakes may not be responsive to braking changes called for by the vehicle operator, such as increasing the wheel brake pressure. Only when the master cylinder pressure is increased to a value above the brake circuit pressure, will brake fluid be forced past the lip seal in the brake circuit isolation valves to increase the brake circuit pressure. However, a partial release of brake pressure will not be transferred beyond the isolation valves. To compensate for such isolation, known brake systems are typically utilize one pressure sensor 54 monitoring the brake fluid pressure in both master cylinder pressure chambers. As described above, the pressure sensor 54 is electrically connected to the ECU 50, as shown by the dashed line. The ECU 50 is responsive to changes in the master cylinder pressure to support the brake pressure algorithms that increase or decrease the hydraulic pressure applied to the individual wheel brakes. The pressure sensor also provides the ECU 50 an initial starting point for pressure estimation while providing information regarding actions of the vehicle operator. With respect to the latter function, when the operator applies the brakes while the system 10 is active, the pressure sensor 54 causes the ECU 50 to pulse open the supply valve 44, allowing a pressure increase. Similarly, if the operator releases the brakes, the pressure sensor 54 detects the pressure drop and causes the ECU 50 to pulse open the dump valves to decrease the wheel brake pressure. As also described above, the brake system may include a second pressure sensor for monitoring the hydraulic fluid pressure in the second master cylinder pressure chamber.

The need to include one or two pressure sensors increases the complexity and cost of the brake system 10. Accordingly, it would be desirable to eliminate the pressure sensors from the electronic brake system. Additionally, if the pressure estimate is not accurate, the open loop control and pressure estimation described above may cause a less than optimal application of brake on the primary wheel for a YSC correction, thereby reducing the desired directional correction moment. If, at the same time, the inaccurate pressure estimate may also affect the application of the brake on the non-YSC control wheel, possibly causing a further reduction of the desired correction moment. The current method of open loop control may prevent a desired further increase in the brake pressure by overestimating the pressure at a wheel brake. Therefore, it would also be desirable to provide a control method that does not rely upon open loop pressure estimation for wheel pressure control.

### BRIEF SUMMARY OF THE INVENTION

This invention relates to an apparatus and method for dynamically controlling the hydraulic pressure within an electronic vehicle brake control system.

The present invention contemplates a brake system for a vehicle that includes at least one wheel brake communicating with a master cylinder and having a normally open isolation valve connected between the master cylinder and the wheel brake. The brake system also includes a motor driven pump having an inlet port and an outlet port with the outlet port connected to the wheel brake. The brake system further includes a normally closed supply valve connected between the master cylinder and the pump inlet port. An electronic control unit is connected to the isolation and supply valves. The control unit also is connected to the pump motor and is selectively operable to actuate the pump and supply valve and to supply a selected current to the isolation valve whereby the pump builds up pressure within the brake system that is a function of the magnitude of the current.

The present invention also contemplates a method for operating the system described above that includes the steps of starting the pump and opening the supply valve. The electronic control unit then supplies a current to the isolation valve to establish a pressure differential across the isolation valve, whereby the differential pressure is a function of the magnitude of the current and the resulting differential pressure is applied to the wheel brake.

In the preferred embodiment, the current supplied to the isolation valve is established by applying a pulse width modulated voltage to the isolation valve with the magnitude of the current determined by the duty cycle of the pulse width modulated voltage.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a typical known electronic vehicle brake control system.

FIG. 2 is an electronic vehicle brake control system in accordance with the present invention.

FIG. 3 is a graph illustrating the relationship between the differential pressure across an isolation valve as a function of the current supplied to the valve winding.

FIG. 4 is a flow chart illustrating an algorithm for the operation of the brake control system shown in FIG. 2.

FIGS. 5A-5C are graphs of wheel brake pressures during operation of the brake control system shown in FIG. 2.

FIG. 6 is a flow chart illustrating a subroutine that may be included in the algorithm shown in FIG. 4.

FIG. 7 is an isometric view of an electronic brake control unit that includes the system shown in FIG. 2.

### DETAILED DESCRIPTION OF THE PREFERRED EMBODIMENT

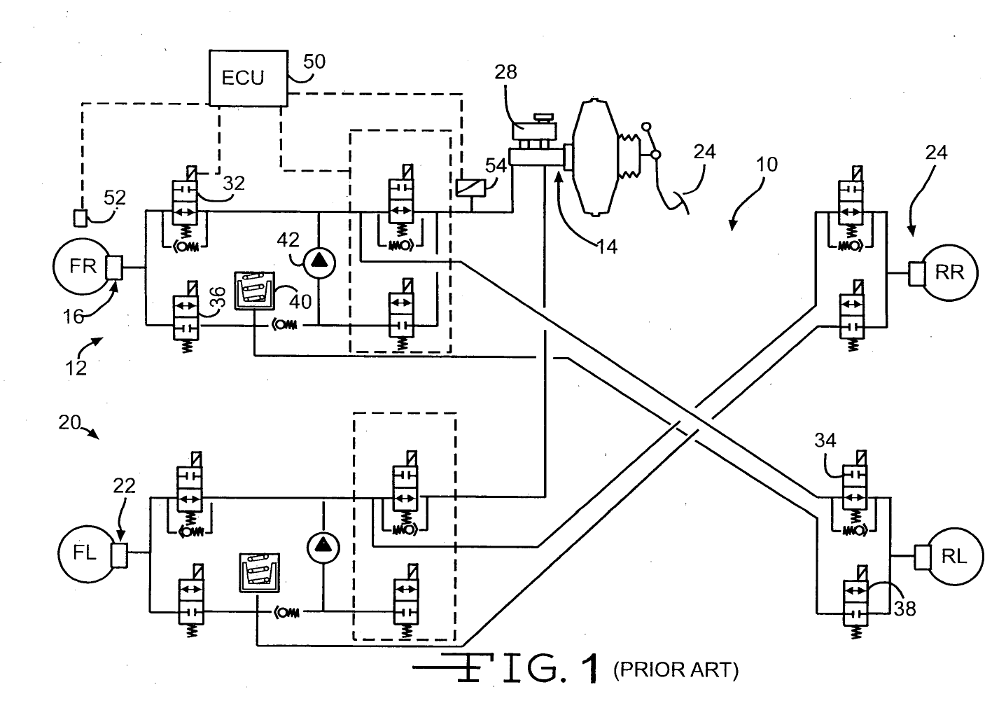

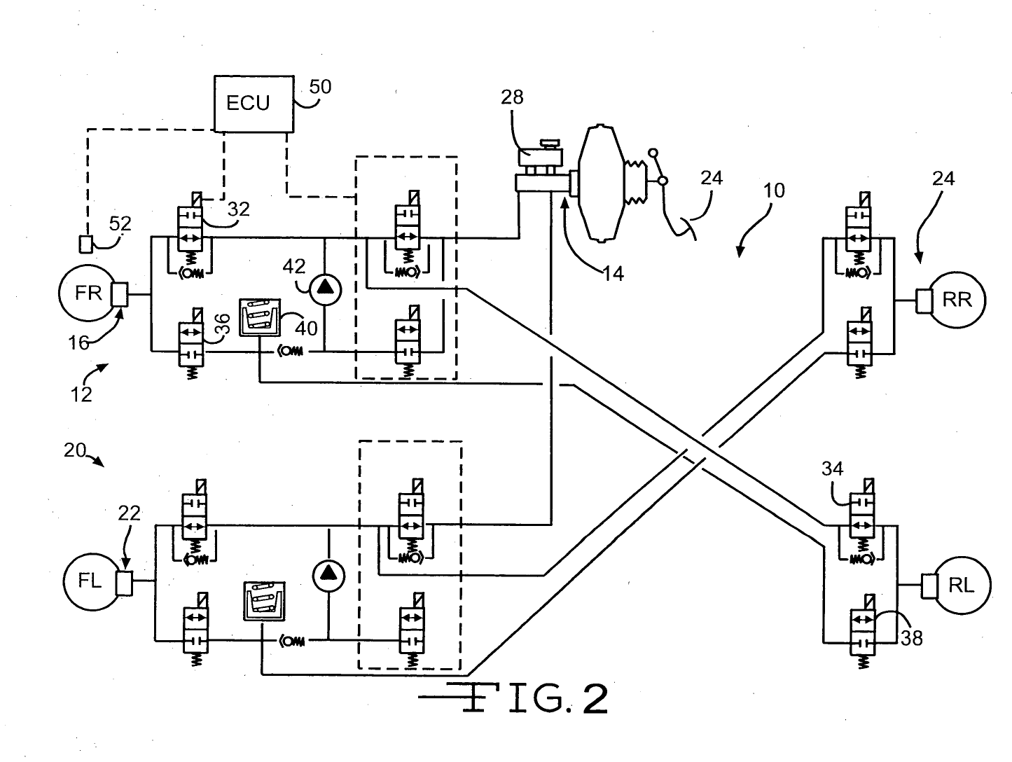

The present invention contemplates an electronic brake system that does not include a brake fluid pressure sensor and a method of operating same. Referring again to the drawings, there is illustrated in FIG. 2 an electronic brake system 60 that is in accordance with the present invention. Components shown in FIG. 2 that are similar to components shown in FIG. 1 have the same numerical identifiers. The brake system 60 is again diagonally split into first and second brake circuits that are labeled 12 and 20, respectively. As described above, the second brake circuit is symmetrically related to the first brake circuit and, in the interest of clarity, the components in the second brake circuit are not specifically identified. The primary difference between the brake system 60 shown in FIG. 2 and the prior art brake system 10 shown in FIG. 1 is the omission of the pressure sensor 54 for monitoring the brake pressure in the prior art brake system.

Considering the first brake circuit 12, the present invention utilizes the brake circuit isolation valve 30 as a pressure relief valve. The force developed by the solenoid that urges the armature of the normally open circuit isolation valve 30 toward its closed position is proportional to the magnitude of the current supplied to the solenoid winding. Also, the valve 30 includes a spring that urges the valve armature toward its open position. Thus, there is a maximum differential pressure, Δp, across the valve 30 that corresponds to the force generated by the solenoid winding. The relationship between Δp and the solenoid current is illustrated in FIG. 3, where the vertical axis represents the differential pressure across the valve, Δp, in bars and the horizontal axis represents the current, I, supplied to the solenoid winding in milliamps. Typically, the solenoid coil is actuated by a Pulse Width Modulated (PWM) voltage having a variable current duty cycle. Since the winding current I is directly proportional to the average value of the PWM voltage which, in turn, is directly proportional to the duty cycle of the voltage, the duty cycle of the PWM voltage is also shown along the horizontal axis in FIG. 3. For illustrative purposes, a linear relationship is shown in FIG. 3; however, a non-linear relationship (not shown) may also exist. For any winding current value shown in FIG. 3, the isolation valve 30 will be closed for any differential pressure Δp below the graph line. However, for any value of winding current I, when Δp is above the graph line, the valve 30 will be urged open as the pressure differential exceeds the force generated by the solenoid winding.

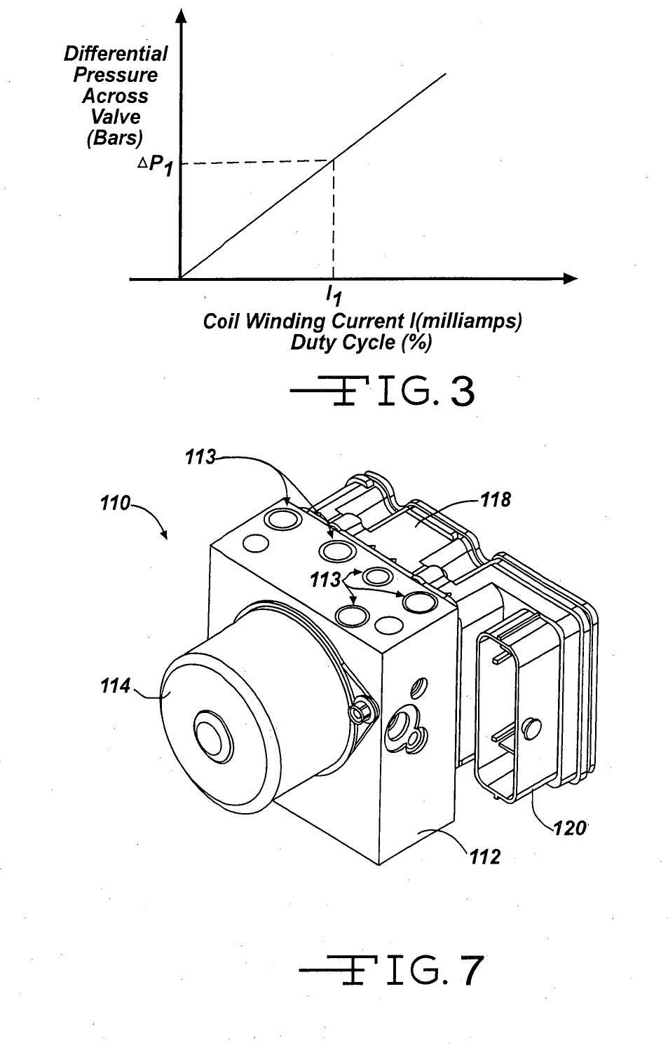

The present invention utilizes the relationship between winding current I and the differential pressure Δp across the valve 30 to control the hydraulic pressure in the corresponding brake circuit. Thus, the present invention contemplates building pressure within the first brake circuit 12 by selective operation of the electronic brake system components included in the first circuit. An algorithm for operation of the invention is illustrated by the flow chart shown in FIG. 4. It will be appreciated that the algorithm shown in FIG. 4 is intended to be exemplary and that the operation of the system 60 may vary from the sequence and details shown in FIG. 4. The algorithm is entered through block 68 and advances to functional block 70, where pump 42 is started and begins to build pressure at its outlet port. The algorithm then advances to functional block 72 where the brake circuit supply valve 44 is opened, allowing brake fluid to flow from the master cylinder reservoir 28 to the inlet port of the pump 42. Because the apply valve 32 for the front right wheel brake 16 remains open while the associated dump valve 36 remains closed, the pressure generated by the pump 42 also is applied to the front right wheel brake 16. The algorithm then continues to functional block 74.

In functional block 74 a predetermined winding current I₁ is applied to the circuit, or TC, isolation valve 30. Based upon the relationship shown in FIG. 3, when the pump outlet pressure reaches the differential pressure Δp₁ that corresponds to I₁, the isolation valve 30 is urged open, establishing a circulating flow path within the first brake circuit 12. If the differential pressure across the circuit isolation valve 30 falls below Δp₁, the valve 30 closes, and the pump increases the fluid pressure until the pressure again reaches Δp₁. The valve 30 again opens, maintaining an equilibrium pressure of Δp₁ within the first brake circuit 12. Effectively, there is a constant flow of brake fluid through the brake circuit isolation valve 30. Thus, the operation of the pump 42 and the isolation and supply valves 30 and 44 can establish a hydraulic pressure within the first brake circuit 12 that is solely a function of the magnitude of the current supplied to the solenoid coil winding of the brake circuit isolation valve 30. The invention also contemplates that the front wheel isolation valve 32 is normally left open and the wheel dump valve 36 is normally left closed. Therefore, the brake circuit pressure generated by the operation of the pump 42 and the brake circuit isolation and supply valves 30 and 44 is applied directly to the front right wheel brake 16.

Because, the brake circuit isolation valve 30 may have a tendency to be held frictionally in one position when an average current is applied, the present invention also contemplates that the current supplied to the winding coil is dithered. Thus, a small amplitude oscillation is applied to the winding coil current to overcome the friction between the valve armature and the valve sleeve. As a result, the differential pressure Δp across the isolation valve 30 remains responsive to changes in the coil current I and any hysteresis effects upon the pressure change responses are minimized.

The differential pressure Δp built across the circuit isolation valve 30 is above the master cylinder pressure. Therefore, if the vehicle operator depresses the brake pedal 24 and increases the pressure exerted by the master cylinder 14, the system 60 will build pressure within the first brake circuit 12 until nearly the same Δp is reached above the increased master cylinder pressure. Thus, the system builds a pressure on the pump side of the brake circuit isolation valve 30 that is supported by the pressure provided by the operator on the master cylinder side of the isolation valve 30. Similarly, if the vehicle operator decreases the pressure supplied to the first brake circuit 12 by the master cylinder, the pressure on the brake side of the brake circuit isolation valve 30 will decrease by the same amount. While the operation of the first brake circuit 12 has been described above, it will be appreciated that the invention contemplates operation of the second brake circuit 20 in the same manner.

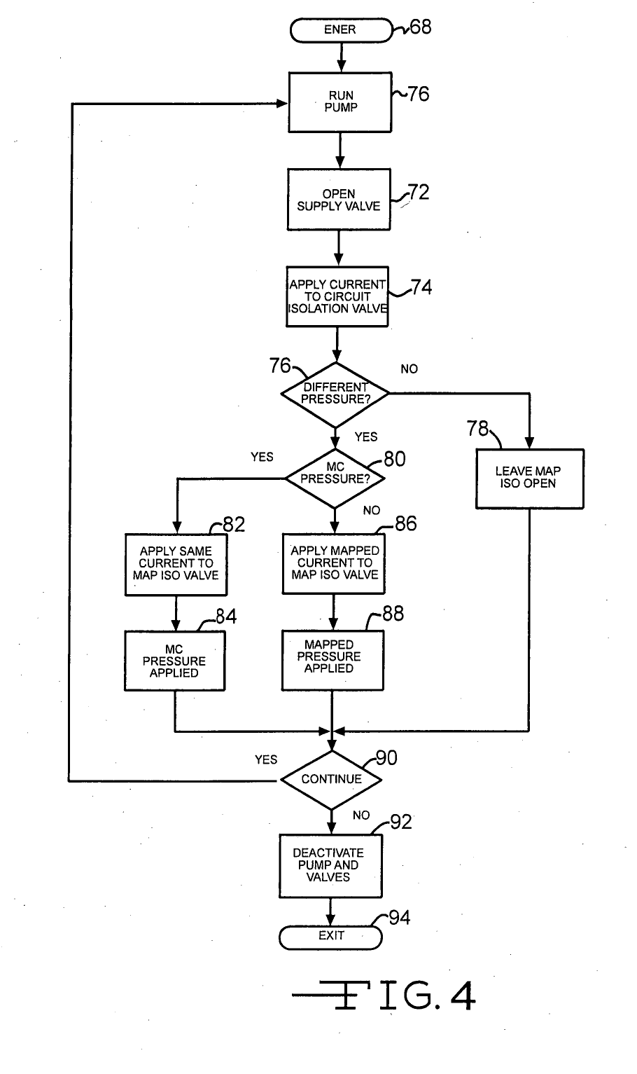

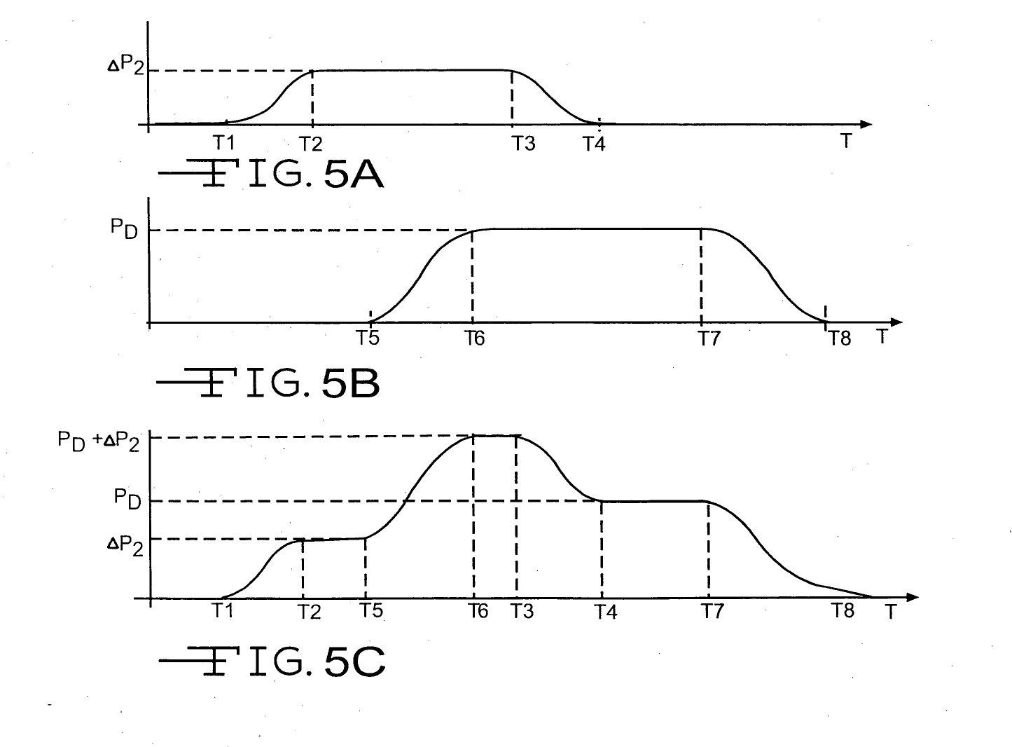

An example of operation of the system 60 is illustrated in FIGS. 5A-5C. In FIG. 5A, a typical wheel brake pressure requirement generated by the ECU 50 in response to sensor signals, such as a YSC correction, is shown. At time t₁, in response to signals received from the wheel speed sensors 52 and/or the vehicle motion sensors, the ECU calls for a wheel brake application. Accordingly, as shown in the flow chart in FIG. 4, the supply valve 44 is opened and the pump 42 is started. A current I₂ is supplied to the coil of the brake circuit isolation valve 30 that corresponds to the desired pressure differential Δp₂ requirement called for by the brake system 60. Accordingly, the pressure supplied to the wheel brake 16 builds to Δp₂, which is reached at t₂. As also shown in FIG. 5A, the brake system pressure requirement continues until the situation is corrected at time t₃, at which time the current is reduced, allowing the brake pressure to return to its original value at t₄. It will be appreciated that, while a constant brake system pressure requirement Δp₂ is shown in FIG. 5A, the magnitude of the pressure requirement may be varied between t₂ and t₃ by the ECU 50 varying the magnitude of the current I supplied to the brake circuit isolation valve winding. In the preferred embodiment, the winding current is varied by changing the duty cycle of the PWM voltage applied to the valve coil.

Continuing the example, in FIG. 5B there is illustrated a brake application called for by the vehicle operator. At time t₅, the vehicle operator depresses the brake pedal 24, raising the brake pressure in the pressure chambers of the master cylinder 14 to an operator demand pressure, P_{D}, which is reached at time t₆. The operator demand bake pressure is then maintained at P_{D} until time t₇, at which time the vehicle operator releases the brake pedal 24. Accordingly, the brake pressure falls to the original value, which is reached at time t₈. For illustrative purposes the operator demand pressure P_{D} is shown as being constant from t₆ to t₇ in FIG. 5B; however, it will be appreciated that the operator demand pressure may vary between t₆ and t₇ as the vehicle operator changes the pressure applied to the brake pedal 24.

The brake system 60 is operative to combine the brake system pressure requirement shown in FIG. 5A with the operator demand brake pressure shown in FIG. 5B to produce the total brake circuit pressure shown in FIG. 5C. Thus, beginning at t₁, the total brake circuit pressure increases to the system requirement of Δp₂ which is reached at t₂. At time t₅, the operator depresses the brake pedal 24 and the brake circuit pressure builds to a total value of Δp₂+P_{D}, which is reached at time t₆. The total pressure is maintained until time t₃, when the brake system pressure requirement ends. Accordingly, the brake circuit pressure then decreases to the operator demand pressure P_{D}, which is maintained until the vehicle operator releases the brake pedal 24 at time t₇. Thus, the system 60 is operative to allow the vehicle operator to push through an active brake system response with his desired brake application. It will be appreciated that the composite curve shown in FIG. 5C is intended to be exemplary of the system operation and that other sequences are possible. Thus, the operator may have already made a brake application before the system calls for additional braking (not shown); however, the response will be similar to that shown in FIG. 5C with the brake system requirement pressure being added to the operator demand pressure.

During the operation of the bake system 60 described above, both the front and rear wheel isolation valves 32 and 34 are held open, which results in the same brake fluid pressure being applied to both the front and rear wheel brakes 16 and 18. However, under certain operating conditions, such as, for example during a YSC correction of vehicle direction, the wheel brakes in one of brake circuits may be required to generate different brake torques to provide a correction brake moment to the vehicle direction. Therefore, the present invention also contemplates utilization of a pressure mapping to provide independent control of the wheel brakes within each of the wheel brake channels that supply the front and rear wheel brakes within each of the brake circuits. Accordingly, for the first brake circuit 12, the same current being supplied to circuit isolation valve 30 is also supplied to the normally open isolation valve 34 that provides brake fluid to the rear left wheel brake 18. Additionally, the rear brake dump valve 38 is selectively activated to allow a circulating flow of brake fluid in the rear brake portion of the first brake circuit 12. In the preferred embodiment, the current is controlled by the duty cycle of the PWM voltage applied to the valve coil. Thus, the same current is provided to the rear isolation valve 34 by using the same duty cycle for the rear isolation valve voltage as applied to the channel isolation valve 30. The result of this is that the rear isolation valve 34 holds off the same amount of pressure Δp built in the brake circuit 12 from the rear wheel brake 18. As a result, while the sum of the master cylinder pressure and the system pressure requirement Δp are applied to the front wheel brake 16, only the master cylinder pressure is applied to the rear wheel brake 18, providing control of the rear wheel brake 18 that is independent of any electronic brake system control.

The mapping described above assumes valves 30 and 34 have same Δp-I response curve. If this is not the case, the invention contemplates that a mapping is used where the current I_{R} supplied to the rear wheel isolation valve 34 is a function of the current I_{F} supplied to the first brake circuit isolation valve 30. The mapping would take into account the different pressure response curves for the two valves 30 and 34. Thus, the current I_{R} applied to the rear brake isolation valve may be either greater than, or less than, the current I_{F} applied to the channel isolation valve 30.

A similar mapping may be utilized in other situations where different brake responses are required for the wheel brakes within a brake circuit. Thus, the system 60 is operable to provide different brake pressures to the wheel brakes in each brake circuit that also are different from the master cylinder pressure.

While the use of mapping of the solenoid currents was described above for the first bake circuit 12, it will be appreciated that the same mapping is also applicable to the second brake circuit 20.

Returning to the flow chart of FIG. 4, the mapping is illustrated in the center portion of the figure. After leaving functional block 74, decision block 76 is reached where the ECU 50 determines whether a pressure other than the circuit pressure Δp is required for the other, or mapped, wheel brake. For the brake system 60 illustrated in FIG. 2, the mapped wheel brake is the rear wheel brake in each of the circuits. If a different pressure is not required, the algorithm transfers to functional block 78 where the rear brake isolation valve 18 is left open. If, in decision block 76, it is determined that a different pressure is required for the other wheel brake in the circuit, the algorithm transfers to decision block 80.

In decision block 80, the algorithm determines whether the master cylinder pressure should be mapped to the other wheel brake. If the mater cylinder pressure is to be mapped, the algorithm transfers to functional block 82 where the same current being applied to the brake circuit isolation valve 30 is also applied to the mapped rear wheel brake isolation valve 34. As described above, in the preferred embodiment, this accomplished by using the same duty cycles for the voltages applied to both isolation valves. It will be appreciated, however, that if the pressure differential—current responses of the isolation valves are different, the current applied to the mapped rear wheel brake isolation valve 34 will be a function of the current applied to the brake circuit isolation valve 30 such that the differential pressure Δp built within the rear brake channel is cancelled at the rear wheel brake 18. As a result, the master cylinder pressure is applied to the rear wheel brake 18, as shown in functional block 84.

If, in decision in block 80, the master cylinder pressure is not to be mapped, the algorithm transfers to functional block 86 where a current is applied to the mapped wheel rear brake isolation valve 34 that is a function of the current applied to the brake circuit isolation valve 30. As a result, the pressure applied to the mapped wheel brake 18 is different from both the master cylinder pressure and the brake circuit pressure. The mapping function utilized is selected by the ECU 50 based upon the desired response. Thus, for example, different mapping functions would be used for YSC and ABS responses of the brake system 60. Also, during an ABS response, the front and rear wheel apply and dump valves would be used.

Upon leaving the selected mapping functional block 84 or 88, or the non-mapping functional block 78, the algorithm advances to decision block 90 where the ECU 50 checks the sensor outputs and determines whether to continue. If further brake control is needed, the algorithm returns to functional block 70 and continues as described above, If, in decision block 90, the ECU 50 determines that further brake control is not needed, the algorithm advances to functional block 92 where the pump 42 is shut off and the valves are deactivated. The algorithm then exits through block 94.

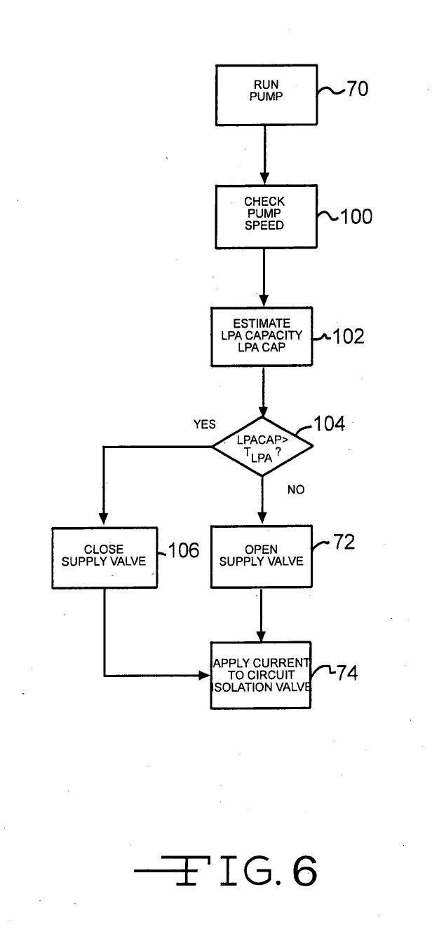

As described above, the pump 42 draws brake fluid from the master cylinder reservoir 28. However, the invention also contemplates that the pump 42 may draw brake fluid from the low pressure accumulator 40. Accordingly, the ECU 50 decides whether the pump 42 draws fluid from the reservoir 28 or the low pressure accumulator 40. In the preferred embodiment, there is a greater demand for fluid when the pump is building pressure and the fluid is supplied from the reservoir 28. Conversely, when the vehicle operator is releasing the brake pedal 24, the total pressure in the brake circuit drops and the low pressure accumulator 40 has sufficient capacity to supply the brake fluid. Since the brake system 60 does not include a pressure sensor for monitoring the master cylinder pressure, the invention includes an alternate method for estimating the fluid content of the low pressure accumulator 40. With the alternate method, the content of the low pressure accumulator 40 is estimated from periodic monitoring of pump speed. A subroutine for monitoring the low pressure accumulator is shown in FIG. 6 where blocks that are same as shown in FIG. 4 have the same numerical identifiers. Thus, the subroutine may be included in the algorithm illustrated in FIG. 4, or the subroutine may be run separately.

As described above, the pump is started in block 70. The algorithm then advances to functional block 100 where the pump speed is checked by momentarily removing the voltage being supplied to the pump 42 and measuring the back electro-motive force, emf, which is directly proportional to the pump speed. The ECU 50 then calculates a rate of change of the pump speed from the measured back emf. Generally, the rate of change of the pump speed is directly proportional to the pressure at the pump outlet port and the volume of fluid entering the pump inlet port. When the rate of change of the pump speed, or the rate of change of the motor back emf, becomes minimal, it is an indication that the low pressure accumulator 40 is empty and not providing fluid to the pump. Accordingly, based upon the rate of change of the measured pump speed, or the rate change of the motor back emf, the content of the accumulator is determined in functional block 102. The subroutine then advances to decision block 104 where the accumulator content determined in block 102 is compared to an accumulator volume threshold, T_{LPA}. If the accumulator content is less than the threshold T_{LPA}, there is an insufficient volume of brake fluid in the accumulator 40 to supply the pump 42 and subroutine advances to functional block 72 where the supply valve 44 is opened, allowing the pump 42 to draw brake fluid from the master cylinder reservoir 28. The subroutine then continues to functional block 74 and follows the algorithm illustrated in FIG. 4 and described above. If, in decision block 104, the accumulator content is greater than the threshold T_{LPA}, there is sufficient volume of brake fluid in the accumulator 40 to supply the pump 42 and subroutine advances to functional block 106 where the supply valve 44 is closed, causing the pump 42 to draw brake fluid from the master cylinder reservoir 28. The subroutine then continues to functional block 74 and follows the algorithm illustrated in FIG. 4 and described above.

While the present invention has been illustrated and described for the first brake circuit 12, it will be appreciated that the invention also contemplates operation of the second brake circuit 20 in the same manner. Thus, the invention contemplates independent control of the hydraulic pressure applied to all four wheel brakes 16, 18, 22 and 24 shown in FIG. 2.

The present invention allows the vehicle operator to automatically pass pressure demands or requirements to both YSC controlled and non-YSC controlled wheel brakes without the use of open loop pressure estimation. Additionally, a master cylinder pressure sensor is not needed. Furthermore, the invention is robust with respect to normal system operating changes due to component wear and is able to detect actual failure of the components.

While the preferred embodiment of the invention has been illustrated and described above for a diagonally split brake system 60, it will be appreciated that the invention also may be practiced with a vertically, or parallel, split brake system (not shown). In a vertically split brake system, the left and right front wheel brakes are included in a first brake circuit and the left and right rear brakes are included in a second brake circuit. Thus, in a vertically split brake system, one wheel brake would be controlled by the differential pressure Δp while the other wheel brake would be controlled by a mapped pressure, as described above. For example, in a front brake circuit, the left front wheel brake could be controlled by the differential pressure while the right front wheel brake could be controlled by the mapped pressure. As before, the vehicle operator would be able to push though the differential and mapped pressures to increase or decrease the total pressure applied to the wheel brakes. Similarly, the invention also may be practiced on any other brake circuit configurations, such as, for example, the wheel brakes on the same side of the vehicle being included in a brake circuit.

The elimination of the prior art master cylinder pressure sensor allows a significant reduction in the size of the electronic control unit utilized in the brake system 60. Accordingly, a compact electronic brake control unit in accordance with the present invention is shown generally at 110 in FIG. 7. The electronic brake control unit 110 includes a hydraulic valve body 112 that includes a number of bores (not shown) formed therein that receive solenoid valve cartridges. A plurality of ports 113 (five shown) formed in the valve body communicate with the solenoid valve cartridges via internal passageways (not shown) formed in the valve body 112 while allowing connection of hydraulic lines from the master cylinder pressure chambers and the individual wheel brakes. The pump 42 and low pressure accumulator 40 are also mounted within the valve body 112 and communicate with the solenoid valves via the internal passageways. A motor 114 mounted upon a surface of the valve body 112 drives the pump 42. An electronic control unit housing 118 also is mounted upon the valve body 112 and includes the microprocessor and other components of the electronic control unit 50 that selectively actuate the solenoid valves. In the preferred embodiment, the electronic control unit housing 118 is removable and carries the solenoid coils (not shown) that actuate the solenoid valves. Each of the coils is electrically connected to the electronic control unit 50 and also slidably receives a corresponding sleeve. The sleeves contain the moveable valve armatures that control the flow of brake fluid through the valve body 112 while also providing fluid seals so that the electronic circuits, to include the solenoid coils, may be removed for testing and servicing without opening the hydraulic brake circuits 12 and 20. An electrical connector 120 is included with the electronic control unit housing 118 to connect the electronic control unit 50 to the wheel speed sensors 52, a vehicle power supply, a vehicle ground and any vehicle motion sensors that are included in the brake system 60. Thus, the brake control unit 110 includes all of the hardware and electronics needed to implement the system 60 and is easily installed in hydraulic brake systems by inserting the unit 110 between the master brake cylinder 14 and the individual wheel brakes 16, 18, 22 and 24.

The overall size of the electronic brake control unit 110 is approximately that of prior art units ABS units that did not include a pressure sensor. In the preferred embodiment, the hydraulic valve body is shaped as a rectangular parallelepiped having a generally square base with sides approximately 100 mm long and a height of approximately 45 mm. However, it will be appreciated that the invention also may be practiced with valve bodies having other shapes and sizes. The present invention contemplates mounting eight or ten solenoid valve cartridges upon the valve body 112; however, depending upon the specific brake system, more or less valve cartridges also may be utilized. Eight valve cartridges would typically be used with ten needed when rear brake TC is included. In addition to ABS and VSC, the inventors contemplate that the brake control unit 110 could be used to provide both oversteer and understeer control, front brake TC and TC for vehicles having rear mounted engines and a limited slip differential. Furthermore, the unit 110 could be used to implement ARC. The uniform small package size provides unexpected advantages in that the vehicle manufactures do not need to meet different space requirements and hydraulic line layout for individual vehicle platforms. Instead, a uniform footprint is provided by the compact control unit 110. The inventors also contemplate that the compact control unit 110 could be integrated with the master brake cylinder 14 to further reduce the brake system complexity while also reducing mass and the overall envelope. Thus, the inventors expect a significant reduction in complexity and manufacturing costs with the use of the control unit. 110. Additionally, the compact control unit 110 may be used with prior art brake systems by either providing an electrical connection to a pressure sensor mounted upon the brake master cylinder 14 or mounting an external pressure sensor upon the valve body 112.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A brake system for a vehicle comprising:
at least one wheel brake;
a master brake cylinder;
a normally open isolation valve connected between said master cylinder and said wheel brake;
a motor driven pump having an inlet port and an outlet port, said outlet port connected to said wheel brake;
a normally closed supply valve connected between said master cylinder and said pump inlet port; and
an electronic control unit connected to said isolation and supply valves, said control unit also connected to said pump motor, said control unit selectively operable to actuate said pump and supply valve and to supply a selected current to said isolation valve whereby said pump builds up pressure within the brake system that is a function of the magnitude of said current.

2. The brake system according to claim 1 further including a compact hydraulic valve body having a plurality of bores formed therein that receive said isolation and supply valves, said valve body also having a bore formed therein that receives said pump, said valve body further having internal passageways formed therein that communicate with said valves and said pump and a plurality of ports connected to said master brake cylinder and said wheel brake.

3. The brake system according to claim 2 wherein said compact valve body is a rectangular parallelepiped having sides that are less than 100 mm long and height that is less than 50 mm.

4. The brake system according to claim 1 wherein said electronic control unit actuates said isolation valve by applying a pulse width modulated to said valve, said pulse width modulated voltage having a variable duty cycle with said duty cycle selected to provide the desired current to said valve.

5. The brake system according to claim 4 wherein said current supplied to said isolation valve is dithered to prevent valve sticking.

6. The brake system according to claim 1 wherein said wheel brake is a first wheel brake and said isolation valve is a first isolation valve and further wherein the brake system also includes a second wheel brake that communicates with said pump outlet port and a second normally open isolation valve between said second wheel brake and said pump outlet port, said second isolation valve being connected to said electronic control unit, said electronic control unit being operative to selectively apply a current to said second isolation valve whereby the pressure applied to said second wheel brake is controlled.

7. The brake system according to claim 6 wherein said current applied to said second isolation valve is one of the same as said current applied to said first isolation valve, and a function of said current applied to said first isolation valve.

8. The brake system according to claim 6 including at least one vehicle parameter sensor connected to said control unit, said control unit being responsive to signals received from said sensor to active the brake system.

9. The brake system according to claim 8 wherein said sensor is a wheel speed sensor.

10. The brake system according to claim 9 further including at least one vehicle motion sensor, said control unit also being responsive to signals received from said vehicle motion sensor.

11. The brake system according to clam 10 further including a steering angle sensor that is electrically connected to said electronic control unit, said steering angle sensor being operative to generate a signal that is a function of the vehicle steering angle and to transmit said signal to said electronic control unit, said control unit also being responsive to signals received from said steering angle sensor.

12. The brake system according to claim 9, wherein said first and second wheel brakes on located on one of the same end of the vehicle, opposite ends of the vehicle, and diagonally opposite corners of the vehicle.

13. A method for controlling a vehicle wheel brake comprising the steps of:
(a) providing a master brake cylinder connected through a normally open isolation valve to the wheel brake, the master cylinder also connected through a normally closed supply valve to an inlet port of a pump, the pump also having an outlet port connected to the wheel brake;
(b) starting the pump;
(c) opening the supply valve; and
(d) supplying a current to the isolation valve to establish a pressure differential across the isolation valve that is a function of the magnitude of the current; and
(e) applying the resulting differential pressure to the wheel brake.

14. The method according to claim 13 wherein the current is supplied in step (d) by applying a pulse width modulated voltage to the isolation valve with the magnitude of the current determined by the duty cycle of the pulse width modulated voltage.

15. The method according to claim 14 wherein step also includes providing a compact hydraulic valve body having a plurality of bores formed therein that receive the isolation and supply valves and the pump, the valve body further having internal passageways formed therein that communicate with the valves and pump and a plurality of ports connected to the master brake cylinder and the wheel brake.

16. The brake system according to claim 15 wherein the compact valve body is a rectangular parallelepiped having sides that are less than 100 mm long and height that is less than 50 mm.

17. A brake system for a vehicle comprising:
at least one wheel brake;
a master brake cylinder;
a normally open isolation valve connected between said master cylinder and said wheel brake;
a motor driven pump having an inlet port and an outlet port with said outlet port connected to said wheel brake;
a supply of brake fluid connected to said pump inlet port; and
an electronic control unit connected to said isolation valve and said motor driven pump, said control unit selectively operable to actuate said pump and to supply a selected current to said isolation valve whereby said pump builds up pressure within the brake system that is a function of the magnitude of said current.

18. The brake system according to claim 17 wherein said supply of brake fluid is said master brake cylinder and further wherein a normally closed supply valve is connected between said master brake cylinder and said pump inlet port, said supply valve being connected to said electronic control unit and selectively actuated thereby to supply brake fluid from said master cylinder to said pump.

19. The brake system according to claim 18 further including a low pressure accumulator that is also connected to said pump inlet port for supplying brake fluid to said pump, said electronic control unit operative to sense the volume of brake fluid contained within said low pressure accumulator and, upon the volume of brake fluid being below a predetermined threshold, to open said supply valve to provide brake fluid to said pump inlet port from said master brake cylinder.

20. The brake system according to claim 19 further including a compact hydraulic valve body having a plurality of bores formed therein that receive said solenoid valves, said valve body also having bores formed therein that receive said pump and said low pressure accumulator, said valve body further having internal passageways formed therein that communicate with said brake system components and a plurality of ports connected to said master brake cylinder and said wheel brake.

21. The brake system according to claim 20 wherein said compact valve body is a rectangular parallelepiped having sides that are less than 100 mm long and height that is less than 50 mm.

22. The brake system according to claim 19 wherein said electronic control unit momentarily interrupts the power being supplied to said motor driven pump and samples the pump motor back electro-motive force; said electronic control unit operative to determine the volume of brake fluid contained within said low pressure accumulator as a function of the rate of change of the pump motor pump motor back electro-motive force and to compare the volume to said predetermined threshold for actuation of said supply valve.

23. The brake system according to claim 17 further including a low pressure accumulator connected to said pump inlet port, said low pressure accumulation operative as said supply of brake fluid to said pump inlet port.

24. The brake system according to claim 23 further including a normally closed supply valve that is connected between said master brake cylinder and said pump inlet port, said supply valve being connected to said electronic control unit, said electronic control unit operative to sense the volume of brake fluid contained within said low pressure accumulator and, upon the volume of brake fluid being below a predetermined threshold, to open said supply valve to provide brake fluid to said pump inlet port from said master brake cylinder.

25. The brake system according to claim 24 wherein said electronic control unit momentarily interrupts the power being supplied to said motor driven pump and samples the pump motor back electro-motive force; said electronic control unit operative to determine the volume of brake fluid contained within said low pressure accumulator as a function of the pump motor pump motor back electro-motive force and to compare the volume to said predetermined threshold for actuation of said supply valve.
